(19) United States
(12) Patent Application Publication
(10) Pub. No.: US 2009/0121055 A1
(43) Pub. Date: May 14, 2009

(54) FOOD PROCESSOR PUSHER WITH CONTOURED GRIP SURFACE

(76) Inventor: Charles Z. Krasznai, Bridgeport, CT (US)

Correspondence Address: Lawrence Cruz;Conair Corporation, One Cummings Point Road, STAMFORD, CT, 06902, US

(21) Appl. No.: 12/267,247

(22) Filed: Nov. 7, 2008

Related U.S. Application Data
(60) Provisional application No. 60/986,470, filed on Nov. 8, 2007.

(51) Int. Cl. B02C 23/02

(52) U.S. Cl. 241/37.5

(57) ABSTRACT

A food pusher 1 for pushing food product through a feed chute of a food processor into a bowl of a food processor includes a wall 2, a top surface 3, a bottom surface 4, and a plurality of raised, dome-shaped bumps 5 on said bottom surface 4. The food pusher 1 may include an internal opening 5 at the bottom surface 4 that is formed by an internal tube 6 that may include a secondary pusher or cap (not shown) as is generally known in the art to enable ingredients to be added to a food processor bowl while the pusher 1 is locked in place.

### CROSS-REFERENCE TO RELATED APPLICATIONS

This application is related to and claims priority from U.S. Provisional Application No. 60/986,470 filed on 8 Nov. 2007.

### BACKGROUND OF THE INVENTION

1. Field of the Invention

The present invention relates to kitchen appliances and, more particularly, to food processors for chopping and mixing food products.

2. Description of Related Art

Various known food processors exist that comprise, generally, a base housing an electric motor, a drive system, a rotatably driven blade, a bowl, a lid, a feed chute, and a feed pusher. The feed chute allows food to be introduced into the bowl while the lid engages the bowl and while the blade is rotating. This contains chopped food product inside the bowl and prevents user's hands from entering the bowl while the device is operating, since the chute is sized so that a user's hand cannot fit through it. In certain devices having a wide chute, a safety mechanism disables the motor until the pusher is engaged in the chute, prohibiting a user's hand from entering. The pusher is sized and shaped to fit inside of the chute and to be slid downwardly, thereby pushing food product that is preloaded into the chute, so that the food product is pushed into the bowl and into the spinning blade. Certain foods engage the blades while simultaneously being pushed by the pusher, resulting in the food being pulled out of and away from the chute so that the pusher can no longer effectively push the food product into the blades for even and controlled cutting.

It is desirable to provide a food pusher that engages food product securely enough to prevent the food from being pulled away from the chute and pusher by a rotating blade.

### OBJECTS OF THE PRESENT INVENTION

It is an object of the present invention to provide a food pusher that engages food product securely enough to prevent the food from being pulled away from the chute and pusher by a rotating blade.

These and other objects are achieved by the present invention.

### BRIEF DESCRIPTION OF THE DRAWINGS

FIGS. 1-7 are various diagrammatic views of the present invention.

### DETAILED DESCRIPTION OF THE PREFERRED EMBODIMENT OF THE INVENTION

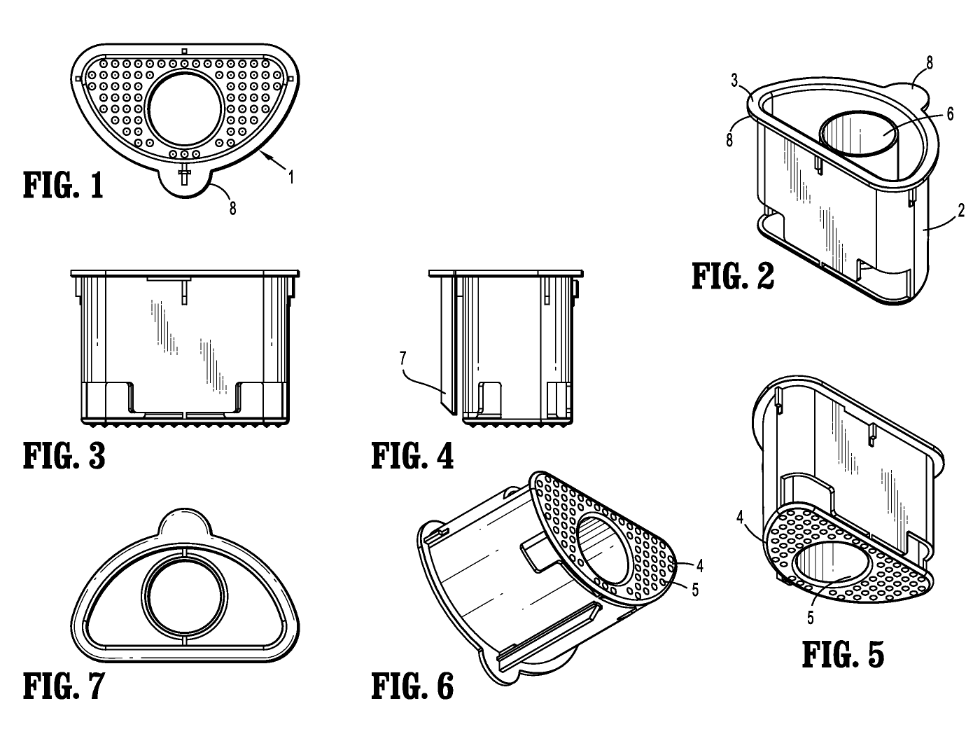

Referring to FIG. 1-7, a food pusher is shown in various external views. In FIG. 1, a bottom view, the bottom surface of the pusher that is adapted to engage food is shown having an array of raised bumps. The perspective bottom views of FIGS. 5-6 also show the raised bumps. The front view of FIG. 3 and the side view of FIG. 4 show the raised bumps in front and side profile. FIGS. 2 and 7 are top perspective and top views showing the upper end of the pusher.

In use, the pusher is introduced into a chute of a food processor as is conventionally known. The pusher is forced into the chute, pushing food product that was pre-loaded into the chute ahead of the pusher. The raised bumps engage the food product and prevent it from slipping relative to the pusher when horizontal forces created by the rotating blade are applied to the food product.

Referring to FIGS. 1-7, a food pusher 1 comprises a wall 2, a top surface 3, a bottom surface 4, and a plurality of raised, dome-shaped bumps 5 on said bottom surface 4. The food pusher 1 may include an internal opening 5 at the bottom surface 4 that is formed by an internal tube 6 that may include a secondary pusher or cap (not shown) as is generally known in the art to enable ingredients to be added to a food processor bowl while the pusher 1 is locked in place. It is also contemplated, however, that the pusher 1 be solid and not include an internal opening 5, tube 6, and associated secondary pusher or cap. Furthermore, the pusher 1 may include a switch engaging member 7 of a type generally known to engage a switch of a food processor and activate the switch to enable operation of the food processor only when the pusher 1 is inserted into the food feed chute and the engaging member 7 engages the switch, as is generally known. The switch engaging member 7 is preferably formed by an elongaged member extending downwardly from a flange 8 of said upper surface 3 and being parallel to said wall 2. said upper surely, the pusher 1 may be constructed without such an engaging member 7 if it is not required or desired. A tab 8 may be formed on the upper surface 7 to be grasped between a user's finger and thumb to facilitate handling of the pusher 1.

While a plurality of dome-shaped bumps 5 are shown in the preferred embodiment, it is contemplated that the bumps 5 may be of one or more various configurations other than dome-shaped bumps that cause the bottom surface 4 to not be smooth, thereby improving friction and gripping ability. For example, the bumps may be prismatic or irregular. In another form, instead of bumps a series of raised ridges or contours may be employed, including in cooperation with depressions. While the preferred embodiment illustrates a food pusher 1 that is generally D-shaped in cross-section, it is contemplated that the present invention novelty of raised bumps may be implemented with other cross-sectional shapes of pusher such as round, square and others.

While the preferred embodiment has been shown and described, various modifications can be made without departing from the scope of the present invention.

What is claimed is:

1. A food pusher for pushing food product through the feed chute of a food processor and into the bowl of a food processor, said pusher comprising
a top surface;
a bottom surface;
a circumferential wall connecting said top surface and said bottom surface; and
a plurality of raised bumps extending from said bottom surface.

2. A pusher according to claim 1 further comprising
a switch engaging member attached to a flange formed on said top surface, said switch engaging member extending from said top surface toward said bottom surface in a generally parallel spaced relationship to said circumferential wall.

3. A pusher according to claim 1, further comprising
a tab extending radially outwardly from said pusher and generally co-planar with said upper surface.

4. A pusher according to claim 1, wherein
said pusher is generally D-shaped in cross section.

5. A pusher according to claim 1, further comprising
a passage extending through said pusher between said top surface and said bottom surface.
